(19) United States
(12) Patent Application Publication
(10) Pub. No.: US 2018/0071940 A1
(43) Pub. Date: Mar. 15, 2018

(54) Method and Device for Conveying Polymeric Oblates to Casting Machines and Application

(71) Applicant: RPC SUPERFOS A/S, TAASTRUP (DK)

(72) Inventor: Søren Djernaes, Pandrup (DK)

(73) Assignee: RPC SUPERFOS A/S, TAASTRUP (DK)

(21) Appl. No.: 15/709,027

(22) Filed: Sep. 19, 2017

Related U.S. Application Data
(63) Continuation of application No. 14/442,169, filed on May 12, 2015, now Pat. No. 9,764,492.

(30) Foreign Application Priority Data
Dec. 7, 2012 (DK) PA 2012 00775

(51) Int. Cl. B26D 7/18; B26F 1/40; B26D 7/02; B65H 16/00; B65H 35/10

(52) U.S. Cl. CPC B26D 7/1863; B26F 1/40; B65H 35/10; B26D 7/025; B65H 16/00; B26D 7/1836

(57) ABSTRACT

A method for conveying pre-printed in-mould labels (IML) in a roller to a casting machine that moulds items such as cups or lids, where the in-mould labels must be integrated in items by being partially punched such that they remain fixed to the roller in points or bridges, after which the roller with the semi-punched in-mould labels is placed on a device from which the roller is rolled out in stages, such that the in-mould labels pass through a tool with holes which are shaped to fit the circumference of the in-mould labels. The in-mould labels are then removed with a device such as a robot with vacuum suction that tears over the river bridges that fix the in-mould labels to the roller and transfers them to the injection casting tool. An apparatus for achieving the method includes an unwinder for attaching a roller of in-mould labels from which the rolled-up in-mould labels are fed through a tool that contains holes which are shaped to fit the circumference of the in-mould labels.

The invention relates to a method for conveying of pre-printed polymer oblates, which are e.g. produced in a so-called flexo printing machine and supplied in a roller, to a casting machine such as an injection press that moulds items such as cups or lids, where the oblates will be integrated in the items.

Furthermore, the invention relates to an apparatus which is suitable for conveying rolled-up printed polymer oblates.

The invention furthermore relates to the use of the apparatus.

It is commonly known to incorporate pre-printed polymer oblates in items such as cups or lids with a view to give the items a trusted and qualitatively attractive exterior.

This technology is typically used for items such as cups and lids as food packaging where items are manufactured in an injection press in which the pre-printed oblate is conveyed to the injection press and thereby integrated into the workpiece when it is moulded.

A pre-printed polymer oblate which is integrated into an item that is injection casted is often referred to as a Inmould Label abbreviated IML.

IML is a plastic film which is typically printed in a so-called flexo printing machine. After printing, a film is laminated onto the product in order to confine the pressure since the material, as mentioned earlier, is often used for packaging in the food industry.

The currently known technology and the method of handling the IML for the conveyance of the oblates to a moulding machine such as an injection press typically comprise the following:

Following lamination, the product is punched with a contour that is matched to the application. After punching, the remaining grid is rolled-up or removed by suction. The individual products are supplied in layers on a conveyor. At this stage of production, the individual products are heavily charged with static electricity, which makes it impossible to assemble products in an acceptable stack for the injection press.

Static electricity occurs when the products are punched out of the web. A lot of effort is put into preventing this condition; for example by adding charged ions to the web before punching. However, this is not sufficient to prevent the static electricity.

From the supply conveyor, the products are stacked to the extent possible—and placed on pallets which are then stocked. After a couple of days, the static electricity is minimised, and the pallet is retrieved. It is now possible to create proper stacks that can be used for injection casting.

The IML stack is placed in a magasine. A handling robot collects an IML by means of vacuum and places it in the injection moulding tool. Here, it is necessary to supply static electricity to the IML so that it can hook onto the tool until this is closed and ready for moulding.

The print shop has striven to eliminate static electricity from IML, whereas static electricity must be supplied to the IML during the moulding process to enable the IML to attach itself to the moulding tool. The fact that the print shop has removed static electricity relatively efficiently, makes it hard to reload the IML.

Another method is to cut the web into sheets. This way, it is possible to create a stack; however, the air between the sheets must be pressed out before storage. In a so-called guillotine, the products are cut into squares. Each stack is pressed through a “sausage roller” into the final shape. This method is problematic, however, since the products tend to coalesce along the edge.

The currently known and most widely used technology has some drawbacks including the following:
It requires a lot of labour and resources to produce a stack of IML oblates
Cutting out the individual IML generates a relatively large amount of waste material
It is difficult and costly to manage static electricity
The initial investment in equipment for the production of IML is relatively large and often constitutes up to one million Euros.

It is therefore an object of the invention to provide a method for handling IML without the above-mentioned drawbacks and to provide an apparatus which is suitable for implementing the method.

The object of the invention is achieved by a method of the type stated in the introduction to claim 1, which is characterized in semi-punching of the oblates such that they remain attached to the roller in the connection points or bridges, after which the roller with the semi-punched oblates is attached to a device from which the roller with the oblates is rolled out in stages, such that the oblates pass through a tool with holes that are shaped to comply to the oblate form, after which an oblate is removed with a device such as a robot that uses vacuum suction to tear over the bridges that hold the oblates onto the roller and then transfers the oblates to the injection press.

In this way, it becomes possible to use pre-printed polymer oblates (IML) without first having to cut them free and stack them, whereby production costs and the initially required investments are reduced by up to 90%.

As previously mentioned, the invention also relates to an apparatus.

The apparatus is characterized in comprising an unwinder for attaching a roller of oblates from which the rolled-up oblates are passed through a tool that contains holes which are shaped to fit the circumference of the oblates.

This makes it possible to convey oblates, including IML, directly from a roller to the tool where e.g. a robot can remove the individual oblates, without prior loosening and stacking, and transfer them to an injection press.

This achieves hitherto unattainable savings in equipment and production costs.

Several appropriate embodiments of the device are shown in claims 3 to 6.

The invention relates, as mentioned before, to the use of the device according to one or more of claims 2 to 6 for conveying the pre-printed, semi-punched polymer ablates from a roller to a robot that tears off the individual oblates from the roller and transfers them to an injection press, which moulds items such as cups or lids onto which the oblates are integrated during the injection press, as indicated by the method described in claim 1.

Using the specific application, the method of claim 1 is efficiently implemented by the apparatus according to one or more of claims 2 to 6.

The invention will now be explained more further with reference to the drawings, in which:

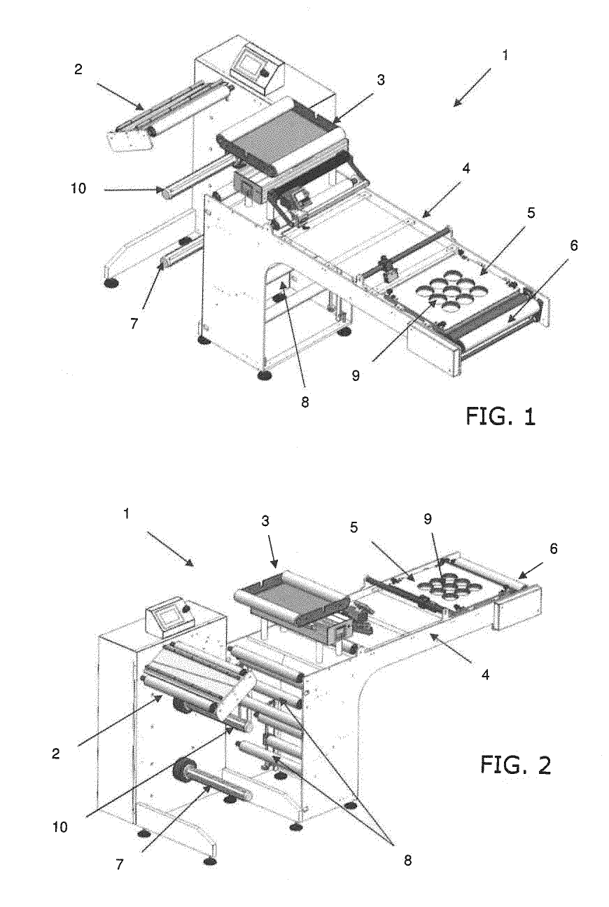

FIG. 1 shows a perspective view of an apparatus which is suitable for conveying rolled-up, pre-printed polymer oblates (IML).

FIG. 2 shows, just as FIG. 1, the same apparatus which is suitable for conveying rolled-up, pre-printed polymer oblates (IML), but from a different angle.

FIG. 1 denotes, as 1 shows, an apparatus which is suitable for conveying rolled-up, pre-printed polymer oblates (IML), which are partially punched, as indicated, by a process which includes that the oblates are semi-punched so that they remain attached to the roller in the bridges, according to which the roller with the semi-punched oblates are placed in an apparatus 1 from which the roller with the oblates is rolled out in stages, feeding the oblates through a tool 5, which consists of an upper and lower part with holes 9 which are shaped to fit the circumference of the oblates, after which an oblate is removed with a unit such as a robot with vacuum suction that tears over the bridges that fix the oblates to the roller and transfers the oblates to the injection press.

In a preferred processing method, the tool 5 is prepared so that the upper part and the lower part with holes 9 are clamped around the film web with oblates for the fixation of the film before the tearing off of an oblate.

The apparatus 1 comprises an unwinder 10 for attaching a roller of oblates from which the rolled-up oblates are conveyed through a tool 5 that is formed with holes 9 which are shaped to fit the circumference of the oblates.

In a preferred processing method as shown in FIG. 1 and FIG. 2, the apparatus is further characterised in a splice table 2 being positioned between the unwinder 10 and the tool 5, which the rolled-up ablates pass after the unwinder 10 from which the rolled-up oblates are conveyed past a so-called web guide 3, and then past a delivery board 4 that guides the rolled-up ablates for positioning through the tool 5

As shown in FIG. 1 and FIG. 2, the apparatus 1 is also fitted with a feeder 6, which can advance the rolled-up oblates through the apparatus 1, where the feeder 6 is positioned after the tool 5.

The apparatus 1 also contains a buffer system 8 which comprises a plurality of spring-loaded rollers to compensate for pulling the rolled-up oblates.

The buffer system reduces the instantaneous characteristics of the rolled-up oblates when they are advanced by the feeder 6.

FIGS. 1 and 2 show that the apparatus 1 also comprises a winder 7 for rolling up roller residue after removal of oblates.

As stated, the invention comprises the use of said apparatus 1 for conveying pre-printed, semi-punched polymer ablates from a roller to a robot that tears off the individual oblates from the roller and transfers them to an injection press that moulds items such as cups or lids where the ablates are integrated into the injection press.

1. A method for conveying of pre-printed polymer oblates (IML), which are e.g. produced in a so-called flexo printing machine and supplied in a roller, to a casting machine such as an injection press that moulds items such as cups or lids, where the oblates will be integrated in the items characterized in semi-punching of the oblates such that they remain attached to the roller in the connection points or bridges, after which the roller with the semi-punched oblates is attached to a device (1) from which the roller with the oblates is rolled out in stages, such that the oblates pass through a tool (5) with holes (9) that are shaped to comply to the oblate form, after which an oblate is removed with a device such as a robot that uses vacuum suction to tear over the bridges that hold the oblates onto the roller and then transfers the oblates to the injection press.

2. Device (1) that is suitable for conveying roiled-up, pre-printed polymer oblates, which are partially punched as indicated in the method according to claim 1, characterized in the fact that the device (1) includes an unwinder (10) for attaching a roller of ablates from which the rolled-up oblates are fed through a tool (5) that contains holes (9) which are shaped to fit the circumference of the oblates.

3. Device (1) according to claim 2 which is characterized in a splice-table (2) being placed between the unwinder (10) and the tool (5) after which the rolled-up oblates pass after the unwinder (10) from which the rolled-up oblates are conveyed past a web guide (3) and then past a delivery board (4) that feeds the rolled-up oblates for positioning through the tool (5).

4. Device (1) according to claim 2 or claim 3, characterised in the fact that the apparatus (1) is provided with a row (6) which can pull rolled oblates forward through the device (1), and wherein the feeder (6) is placed after the tool (5).

5. Device (1) which, according to one or more of claims 2 to 4, is characterised in that the device (1) includes a buffer system (8) that contains a number of rollers for equalisation of traction in rolled-up oblates.

6. Device (1), which, according to one or more claims 2 to 5, is characterised in that the device (1) includes a winder (7) for rolling-up roller residue after removal of oblates.

7. Application of the device (1) according to one or more of claims 2 to 6 for conveying of pre-printed, semi-punched polymer oblates from a roller to a robot that tears off the individual oblates from the roller and transfers them to an injection moulding tool that moulds items such as cups or lids, onto which the oblates are integrated in the injection press, as indicated by the method described according to claim 1.
